(19) United States
(12) Patent Application Publication
(10) Pub. No.: US 2005/0262354 A1
(43) Pub. Date: Nov. 24, 2005

(54) Multiple signature apparatus, multiple signature method and computer program product

(75) Inventor: Yuichi Komano, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/010,603

(22) Filed: Dec. 14, 2004

(30) Foreign Application Priority Data
May 19, 2004 (JP) 2004-149506

(51) Int. Cl. H04L 9/00

(52) U.S. Cl. 713/177

(57) ABSTRACT

A multiple signature apparatus includes a determining unit that determines whether signature information of a specific signer is included in multiple signatures created by a plurality of signers for message data. The multiple signature apparatus also includes a signature deleting unit that deletes the signature information of the specific signer from the multiple signatures based on intermediate information created from the message data during creation of a signature by the specific signer if the determining unit determines that the signature information of the specific signer is included in the multiple signatures.

### CROSS-REFERENCE TO RELATED APPLICATIONS

This application is based upon and claims the benefit of priority from the prior Japanese Patent Application No. 2004-149506 filed on May 19, 2004 the entire contents of which are incorporated herein by reference.

### BACKGROUND OF THE INVENTION

1) Field of the Invention

The present invention relates to a multiple signature apparatus, a multiple signature method and a computer program product that create and manage a set of multiple signatures created by allowing a plurality of signers to sequentially performing electronic signature creation processings on certain message data. More specifically, the present invention relates to a multiple signature apparatus, a multiple signature method and a computer program product capable of deleting or updating signature information of a specific signer in a plurality of signatures.

2) Description of the Related Art

There is known a multiple signature scheme as an applied scheme to a scheme for attaching an electronic signature to message data. The multiple signature scheme is a technique for creating a single electronic signature by allowing a plurality of signers to sequentially perform electronic signature generation processings on certain message data. The multiple signature scheme is employed in, for example, a system in which a plurality of persons sequentially and electronically seal message data circulated in a certain organization for approval.

A size of the single electronic signature obtained by this multiple signature scheme is smaller than that of an electronic signature obtained by creating electronic signatures for certain message data by a plurality of signers independently of one another, and by connecting the respective electronic signatures thus created.

Recently, an aggregate signature scheme that belongs to this multiple signature scheme has been proposed. According to multiple signature schemes other than the aggregate signature scheme, the respective signers perform the signature creating operations so as to constitute multiple signatures. According to the aggregate signature scheme, by contrast, the respective signers create electronic signatures that can be verified independently and then the electronic signatures thus created are aggregated into a single electronic signature if it is necessary to do so.

As a typical multiple signature scheme, a multiple signature method using an ElGamal signature scheme based on difficulty of an elliptic curve discrete logarithm problem is disclosed (see, for example, Japanese Patent Application Laid-Open No. H10-153956).

If such a multiple signature method is used, and if a leakage of a secret key of a certain signer that is used for multiple signatures causes a secret key of the certain signer updated and used in the past to be cancelled, or if a signer in a certain department of a company who attached a signature among the multiple signatures loses his or her signature right because of shifting to another department and the secret key of the signer is cancelled, it is often necessary to update the secret key.

If the key needs to be updated for the multiple signatures created in the past, the conventional multiple signature scheme needs to perform a verification processing for verifying validity of the invalid key, a storage region that stores data necessary for signature verification for the key, and the invalid signature.

In addition, if the invalid key is cancelled, multiple signature verification cannot be performed according to the conventional multiple signature scheme. It is, therefore, necessary to create new multiple signatures by signers that own signature rights.

The conventional multiple signature scheme is intended to create a set of multiple signatures by different signers. Actually, however, the same signer is often involved in the multiple signatures a plurality of times.

For example, in a system in which a plurality of medical institutions share patient's charts therebetween and signatures of the institutions are created whenever a content of each chart is updated, the multiple signature scheme is adopted so as to reduce a signature storage region. In this system, the following instance may be considered. A certain patient takes medical advice in a medical institution A, receives a signature of the institution A, takes medical advice in a medical institution B, receives a signature of the institution B, and then takes medical advice in the institution A again.

In this instance, by creating multiple signatures in which the signature of the medical institution A is reflected twice and that of the medical institution B is reflected once, the conventional multiple signature scheme can be used.

According to the conventional multiple signature scheme, however, information of a signer is often added whenever the signer attaches a signature such as attachment of an identifier of each signer when the signer creates a signature so as to be able to specify a verification key (public key) during, for example, verification of signatures. For this reason, in the above instance, a storage region for storing information of the medical institution A twice is required, with the result that a total size for the necessary storage region is disadvantageously increased.

Furthermore, a signature verification processing using the verification key of the medical institution A needs to be performed twice, with the result that it disadvantageously takes lots of time to perform a multiple signature verification processing.

The same disadvantages occur when point cards relating to special favors are shared among a plurality of shops. Specifically, if point cards of the same type are shared among shops in different categories of business, e.g., between home electric appliance mass marketers and music CD rental stores, or between airways and tourist societies or tourist facilities, in the future, the multiple signature scheme can be used instead of preparing a common server and managing client information. More specifically, special favor points and signatures of companies or stores that issue the points are stored in a point card owned by each client, whereby a size of a signature storage region can be reduced.

Nevertheless, if the same company has dealings a plurality of times, it is necessary to secure a storage region that stores information of the same company as much as the number of dealings similarly to the instance of the medical institutions. In addition, a signature verification processing for verifying the signature of the same company a plurality of times is disadvantageously excessive.

The conventional multiple signature scheme is thus confronted with the disadvantages in that if the same signer performs the signature creation processing a plurality of times, a storage region that correspond to the number of signatures is necessary despite the signatures by the same signer. As a result, the total size of the necessary storage region is increased.

Moreover, if the same signer attaches signatures a plurality of times, it takes lots of labor and time to perform the signature verification processing despite the signatures by the same signer.

### SUMMARY OF THE INVENTION

It is an object of the present invention to at least solve the problems in the conventional technology.

A multiple signature apparatus according to one aspect of the present invention includes a determining unit that determines whether signature information of a specific signer is included in multiple signatures created by a plurality of signers for message data; and a signature deleting unit that deletes the signature information of the specific signer from the multiple signatures based on intermediate information created from the message data during creation of a signature by the specific signer if the determining unit determines that the signature information of the specific signer is included in the multiple signatures.

A multiple signature apparatus according to another aspect of the present invention includes a determining unit that determines whether signature information of a specific signer is included in multiple signatures created by a plurality of signers for message data; a signature deleting unit that creates intermediate multiple signature information obtained by deleting the signature information of the specific signer from the multiple signatures based on intermediate information created from the message data during creation of a signature by the specific signer if the determining unit determines that the signature information of the specific signer is included in the multiple signatures; and a signature creating unit that creates new multiple signatures based on the intermediate multiple signature information and the message data if the determining unit determines that the signature information of the specific signer is included in the multiple signatures.

A multiple signature method according to still another aspect of the present invention includes determining whether signature information of a specific signer is included in multiple signatures created by a plurality of signers for message data; and deleting the signature information of the specific signer from the multiple signatures based on intermediate information created from the message data during creation of a signature by the specific signer if the determining unit determines that the signature information of the specific signer is included in the multiple signatures.

A multiple signature method according to still another aspect of the present invention includes determining whether signature information of a specific signer is included in multiple signatures created by a plurality of signers for message data; creating intermediate multiple signature information obtained by deleting the signature information of the specific signer from the multiple signatures based on intermediate information created from the message data during creation of a signature by the specific signer if the determining unit determines that the signature information of the specific signer is included in the multiple signatures; and creating new multiple signatures based on the intermediate multiple signature information and the message data if the determining unit determines that the signature information of the specific signer is included in the multiple signatures.

The computer program product according to still another aspect of the present invention causes a computer to perform the method according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram that depicts a functional configuration of a multiple signature apparatus according to a first embodiment;

FIG. 2 is an explanatory view that depicts a concept of a multiple signature scheme based on L signers using the multiple signature apparatuses according to the first embodiment;

FIG. 3 is an explanatory view that depicts a concept of message flexibility;

FIG. 4 is a flowchart that depicts procedures for a signature deletion processing using the multiple signature apparatus according to the first embodiment;

FIG. 5 is a flowchart that depicts procedures for a signature deletion processing using a multiple signature apparatus according to a second embodiment;

FIG. 6 is a block diagram that depicts a functional configuration of a multiple signature apparatus according to a third embodiment;

FIG. 7 is a flowchart that depicts procedures for a signature deletion processing using the multiple signature apparatus according to the third embodiment;

FIG. 8 is a block diagram that depicts a functional configuration of a multiple signature apparatus according to a fourth embodiment;

FIG. 9 is a flowchart that depicts procedures for a signature deletion processing using the multiple signature apparatus according to the fourth embodiment;

FIG. 10 is a block diagram that depicts a functional configuration of a multiple signature apparatus according to a fifth embodiment;

FIG. 11 is a flowchart that depicts procedures for a signature deletion processing using the multiple signature apparatus according to the fifth embodiment;

FIG. 12 is a flowchart that depicts procedures for a signature update processing using a multiple signature apparatus according to a sixth embodiment;

FIG. 13 is a block diagram that depicts a functional configuration of a multiple signature apparatus according to a seventh embodiment;

FIG. 14 is a flowchart that depicts procedures for a signature update processing using a multiple signature apparatus according to a seventh embodiment;

FIG. 15 is a block diagram that depicts a functional configuration of a multiple signature apparatus according to the seventh embodiment; and

FIG. 16 is a flowchart that depicts procedures for a signature update processing using a multiple signature apparatus according to an eighth embodiment.

### DETAILED DESCRIPTION

Exemplary embodiments of a multiple signature apparatus and a multiple signature method relating to the present invention will be explained in detail below with reference to the accompanying drawings.

A multiple signature apparatus according to a first embodiment deletes an electronic signature of a signer a secret key of whom becomes unnecessary, among signers involved in multiple signatures in the past from the multiple signatures attached to message data.

The multiple signature apparatus according to this embodiment creates a signature for the message data, transmits the signature to other multiple signature apparatuses, verifies multiple signatures for the message data, manages the multiple signatures, and delete the signature of a specific signer.

In this embodiment, a plurality of multiple signature apparatuses are connected to a network such as the Internet. Each signer creates an electronic signature using one of the multiple signature apparatuses, and transmits the message data and multiple signatures to the other multiple signature apparatus on the network. When receiving the message data, the other multiple signature apparatus performs a verification processing on the multiple signatures for the received message data, creates multiple signatures using a secret key owned by the apparatus, and transmits the message data and the multiple signatures thus created to the other multiple signature apparatus on the network.

If the signature of a certain signer becomes unnecessary due to invalidation of the secrete key of the certain signer or the like, the signer or a system administrator of the multiple signature apparatus can delete the signature of the certain signer from the multiple signatures using the multiple signature apparatus.

A signature creation processing, a multiple signature verification processing, a multiple signature management processing including signature deletion may be executed by different apparatuses, respectively.

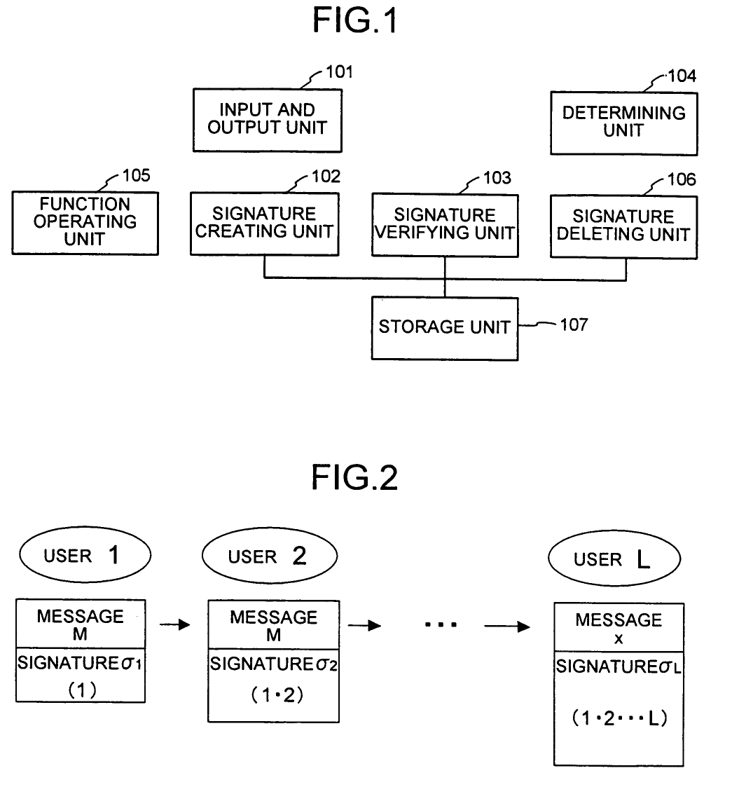

FIG. 1 is a block diagram that depicts a functional configuration of the multiple signature apparatus according to the first embodiment. As shown in FIG. 1, the multiple signature apparatus in this embodiment includes an input and output unit 101, a signature creating unit 102, a signature verifying unit 103, a determining unit 104, a function operating unit 105, a signature deleting unit 106, and a storage unit 107.

The input and output unit 101 inputs and outputs the message data and the multiple signatures for the message data from and to the other multiple signature apparatuses.

The signature creating unit 102 creates a signature for the message data. The signature verifying unit 103 verifies the multiple signatures for the message data input from the input and output unit 101.

The determining unit 104 determines whether the signature of a specific signer to be deleted is included in the multiple signatures input by the input and output unit 101.

The function operating unit 105 outputs a random function to the message data. In this embodiment, the function operating unit 105 operates an authentication code (a hash) of the message data using a hash function H. The hash function H is a function that performs an operation by a method dependent on all bits of a correspondence having an arbitrary size, and that outputs a function having a fixed length. If an arbitrary correspondence M and an arbitrary hash function H(M) are given, in particular, it is quite difficult to find another correspondence X that satisfies H(M)=H(X). As the hash function H, MD5 (Message Digest #5) or SHA-1 (Secure Hash Algorithm #1) can be used. The authentication code (hash) of the message data is also used as encrypted message information or authentication code information.

The signature deleting unit 106 deletes the signature of the certain signer among the signers involved in the multiple signatures for the input message data from the multiple signatures. The storage unit 107 is a memory that stores the secret key of the signer that is a user of the multiple signature apparatus.

The multiple signature processing using the multiple signature apparatus thus constituted according to the first embodiment will next be explained.

FIG. 2 is an explanatory view that depicts a concept of a multiple signature scheme based on L signers using the multiple signature apparatuses according to the first embodiment. As shown in FIG. 2, after a user 1 that is a first user in a signature order creates a signature 61 for a message M, the user 1 transmits the message M and the signature σ₁ to a user 2 that is a second user in the signature order. The user 2 creates a signature σ₂ using the signature σ₁. The signature σ₂ is a signature that secures that both the user 1 and the user 2 approves the message M, and that is smaller in size than data of simple connection of the signature σ₁ of the user 1 with the signature σ₂ of the user 2. Thereafter, the same processings are performed up to a user L that is an L^{th} user in the signature order, thereby creating a set of multiple signatures (hereinafter, “multiple signature set”) σ_{L}.

The multiple signature scheme typically includes additional functions of a message flexibility, an order flexibility, and an order verifiability. The message flexibility is a function that enables creating the multiple signature set while updating or changing a message when the message is circulated among a plurality of users.

The order flexibility is a function that enables freely changing the signature order until creating the signatures. The order verifiability is a function that enables verifying the order of the signers who creates signatures in a multiple signature verification processing. If the signature order is verifiable in a certain multiple signature scheme and a multiple signature set created by L signers is received, then a verifier can confirm that a signer that is a second signer in the order approves the message and that a first signer in the order creates the signature for the message.

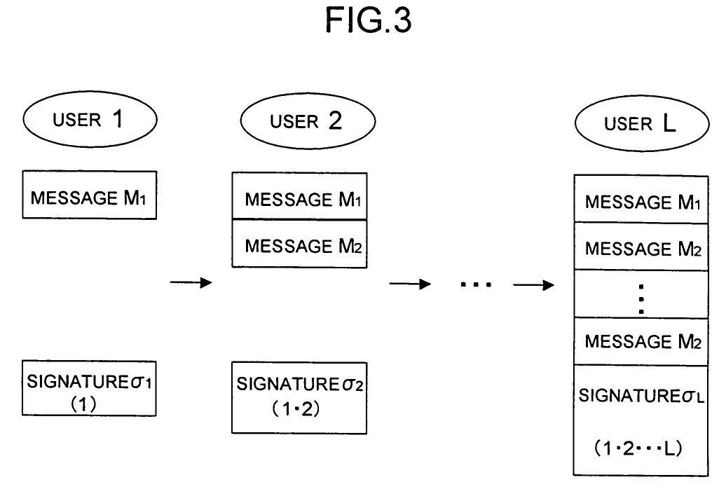

FIG. 3 is an explanatory view that depicts a concept of the message flexibility. The user 1 that is the first in the order creates the signature σ₁ for a message M₁. The user 2 that is the second in the order updates or changes the message M₁, sets differential information as a message M₂, and creates the signature σ₂ for the messages M₁ and M₂ using the signature σ₁. The signature σ₂ is a signature that secures that the user 1 approves the message M₁ and that the user 2 approves the messages M₁ and M₂. Thereafter, the same processings are performed up to the signer L that is the L^{th} in the order, thereby creating the multiple signature set σ_{L}.

The multiple signature apparatus according to this embodiment adopts the multiple signature scheme that includes the message flexibility, the order flexibility, and the order verifiability.

According to this embodiment, the multiple signature apparatus adopts an aggregate signature scheme disclosed in D. Boneh, C. Gentry, B. Lynn, and H. Shacham: “Aggregate and Verifiability Encrypted Signature form Bilinear Maps”, Advances in Cryptology—EUROCRYPT 2003, Springer-Verlag, 2003, Lecture Notes in Computer Science 2656 (hereinafter, “Boneh et al.”). The other multiple signature scheme is similarly applicable to the multiple signature apparatus according to the first embodiment.

Meanwhile, each signer has identification information ID[i], where i in this ID[i] is regarded identical to a turn i of the signer in the signature creation order. Generally, the signature order is not always determined according to an identifier order. However, by making the signer's turn in the signature order correspond to the identification information of the signer who creates the signature in his or her turn in the order, it is possible to identify the signature as the turn in the signature order.

The identification information ID[i] on the signer is important for grasping the public key of which signer can be activated in which turn in the order during the multiple signature verification based on the multiple signature scheme that includes the order flexibility according to this embodiment. The identifier of each signer can be transmitted while being added to the signature of the signer. In this embodiment, using the message flexibility, the signer can add the message data which the signer approves and the signer's identification information to message data received from a signer earlier in the signature order, thereby creating new message data. In addition, the signer can execute the signature creation processing, and transmit the new message data to the next signer in the order.

The hash function H used in this embodiment and a size of input and output data on the function will be explained. Signature creation, signature verification, and signature deletion operations are performed on a general group theory according to the Boneh et al. More specifically, as indicated by the Boneh et al., an elliptic curve can be used.

General consideration of elliptic curves is explained in detail in J. H. Silverman: “The Arithmetic of Elliptic Curves”, Graduate Texts in Mathematics 106, Springer-Verlag, 1986 (hereinafter, “J. H. Silverman”). Operations performed when the first embodiment is constituted using the elliptic curve is explained in detail in D. Boneh, B. Lynn, and H. Shacham: “Short Signatures from the Weil Pairing”, Advances in Cryptology—ASIACRYPT 2001, Springer-Verlag, 2001, Lecture Notes in Computer Science 2248, page 514-532) and Washington: Elliptic Curves—Number Theory and Cryptography—, CHAPMAN & HALL/CRC, 2003 (hereinafter, “Washington”).

According to the Boneh et al., p and q are assumed as a pair of prime numbers that satisfy a relationship of p=2q+1. G1, G2, and GT are assumed as groups at a position number q, and generators of the G1 and G2 are denoted by g1 and g2, respectively.

Symbol e is assumed as a bilinear map from G1×G2 to GT, and H is assumed as the hash function for mapping data having an arbitrary length to the group G1. The bilinear map e satisfies relationships of e(ua, vb)=e(u, v)ab (bilinearity) and e(g1, g2)≠1 (non-degenerate) where uεG1, vεG2, and a, bεZ.

If the elliptic curve is used, Weil Pairing or Tate Pairing is used for the bilinear map e. A Weil Pairing calculation method is explained in the Washington in detail. A Tate Paring calculation method is described in Tetsuya Izu and Tsuyoshi Takagi: “Fast Tate Pairing Calculation Method (if MOV degree is high)”, The Institute of Electronics, Information and Communication Engineers (“IEICE”) Information Security (“ISEC”), IEICE Technical Report Vol.102, No.744, ISEC2002-143.

Each signer that has the identification information ID[i] selects xi from {0,1, . . . , q−1} at random, and owns Iᵢ=g^{xi} as a public key and xᵢ as a secret key. The hash function H is a function for mapping the data having the arbitrary size to a generator of a group generated by g′, and g′ is not included in a group generated by g.

On this presumption, the multiple signature apparatus according to the first embodiment performs the signature creation processing as follows. The i^{th} multiple signature apparatus in the signature order receives message data M, a signature σᵢ₋₁, and identification information ID that are output by an (i−1)^{th} signer, as well as message data Mᵢ to which an i^{th} signer attaches a signature, from the input and output unit 101. The function operating unit 105 calculates a hash H(Mᵢ) of the received message data Mᵢ. The signature creating unit 102 calculates a signature expressed by the following Equation (1) using the hash H(Mᵢ) and the secret key xᵢ stored in the storage unit 107.
σᵢ=σᵢ₋₁H(Mᵢ)^{xi} (1)
In Equation (1), H(Mᵢ)^{xi} is intermediate information. The input and output unit 101 then outputs the message data M=M∥Mᵢ, the multiple signature set σᵢ, and the identification information ID=ID∥IDᵢ.

The multiple signature apparatus according to this embodiment performs the signature verification processing as follows.

The input and output unit 101 receives message data M=M₁∥ . . . ∥M_{L}, the multiple signature set σ_{L}, and identification information ID=ID₁∥ID₂∥ . . . ∥ID_{L} from the other multiple signature apparatus. The public information g input from the input and output unit 101, a public key Iᵢ of each signer specified by the identification information IDᵢ, the hash H(Mᵢ) of each message Mᵢ calculated by the function operating unit 105, and the multiple signature set σ_{L} are input to the signature verifying unit 103. The signature verifying unit 103 determines whether the following Equation (2) is established.
e(g, σ_{L})=Πe(Iᵢ, H(Mᵢ)) (2)
In Equation (2), symbol i corresponds to the identifier ID[i] of each signer involved in the multiple signatures. If Equation (2) is established, then the multiple signature set σ_{L} is accepted. If not established, the multiple signature set σ_{L} is cancelled.

If the multiple signature set σ_{L} is normally created, it can be determined whether the multiple signature set σ_{L} is accepted during the signature verification processing as follows.

A multiple signature set σ_{L′} normally created by L′ signers is expressed by the following Equation (3).

$$\begin{matrix}{σ}_{{L}^{′}} = {H ( {M}_{1} )}^{{x}_{1}} … {H ( {M}_{{L}^{′}} )}^{{x}_{{L}^{′}}} \\ = {g}^{′Log [ {g}^{′} , {H ( {M}_{1} )}^{x1} ] + … + Log [ {g}^{′} , {H ( {M}_{{L}^{′}} )}^{{xL}^{′}} ]}\end{matrix} \qquad ( 3 )$$

The verification Equation (2) for which it is determined whether Equation (2) is established during the signature verification is directed to the following Equation (4).

$$\begin{matrix}e ( g , {σ}_{{L}^{′}} ) = e ( g , {H ( {M}_{1} )}^{{x}_{1}} … {H ( {M}_{{L}^{′}} )}^{{x}_{{L}^{′}}} \\ = e ( g , {g}^{′Log [ {g}^{′} , {H ( {M}_{1} )}^{x1} ] + … + Log [ {g}^{′} , {H ( {M}_{{L}^{′}} )}^{{xL}^{′}} ]} \\ = {e ( g , {g}^{′} )}^{Log [ {g}^{′} , {H ( {M}_{1} )}^{x1} ] + … + Log [ {g}^{′} , {H ( {M}_{{L}^{′}} )}^{{xL}^{′}} ]} \\ = {e ( g , {g}^{′} )}^{Log [ {g}^{′} , {H ( {M}_{1} )}^{x1} ]} … {e ( g , {g}^{′} )}^{Log [ {g}^{′} , {H ( {M}_{{L}^{′}} )}^{{xL}^{′}} ]} \\ = e ( g , {g}^{Log [ {g}^{′} , {H ( {M}_{{L}^{′}} )}^{{x1}^{′}} ]} ) … e ( g , {{g}^{′}}^{Log [ {g}^{′} , {H ( {M}_{{L}^{′}} )}^{{xL}^{′}} ]} ) \\ = e ( g , {H ( {M}_{1} )}^{x1} ) … e ( g , {H ( {M}_{{L}^{′}} )}^{{xL}^{′}} ) \\ = {e ( g , H ( {M}_{1} ) )}^{x1} … {e ( g , H ( {M}_{{L}^{′}} ) )}^{{xL}^{′}} \\ = e ( {g}^{{x}_{1}} , H ( {M}_{1} ) ) … e ( {g}^{{x}_{{L}^{′}}} , H ( {M}_{{L}^{′}} ) ) \\ = e ( {I}_{1} , H ( {M}_{1} ) ) … e ( {I}_{{L}^{′}} , H ( {M}_{{L}^{′}} ) ) \\ = Π e ( {I}_{i} , H ( {M}_{i} ) )\end{matrix} \qquad ( 4 )$$

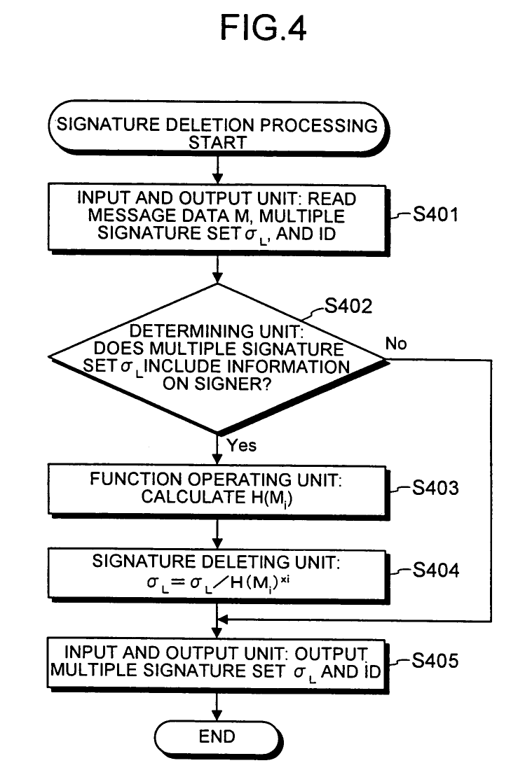

The signature deletion processing performed by the multiple signature apparatus according to the first embodiment will be explained. FIG. 4 is a flowchart that depicts procedures for the signature deletion processing using the multiple signature apparatus according to the first embodiment. In the first embodiment, an instance in which the secret key of a signer involved in the multiple signatures in the past is invalidated and in which the multiple signature apparatus owned by the signer performs the signature deletion processing for deleting the signature of the signer from the multiple signatures will be explained.

The input and output unit 101 reads the message data M=M₁∥ . . . ∥M_{L}, the multiple signature set σ_{L}, and the identifier ID=ID[1]∥ . . . ∥ID[L] (at step S401). The determining unit 104 determines whether signature information of the signer the signature of whom is to be deleted is included in the input multiple signature set σ_{L} based on the identification information added to the signature (at step S402).

If the determining unit 104 determines that the signature information of the signer is includes as it signature information in the multiple signature set σ_{L} (“Yes” at step S402), the function operating unit 105 calculates the hash H(Mᵢ) (authentication code of the message data Mᵢ) for the message data Mᵢ changed by the apparatus itself (at step S403). The signature deleting unit 106 generates intermediate information H(Mᵢ)^{xi} using the hash H(Mᵢ) and the secret key xᵢ of the signer stored in the storage unit 107.

The multiple signature set σ_{L} is replaced by a multiple signature set obtained by performing a reverse operation on the generated intermediate information (at step S404) as expressed by the following Equation (5).

$${σ}_{L} = \frac{{σ}_{L}}{{H ( {M}_{i} )}^{{x}_{i}}} \qquad ( 5 )$$

At this time, the message Mᵢ in the message data and the identifier ID[i] of the signer in the identification information ID are deleted, thereby updating the message and the identifier. The input and output unit 101 outputs the updated message and identifier together with the replacement multiple signature set (at step S405).

If it is determined at step S402 that the signature information of the signature is not included in the multiple signature set σ_{L} (“No” at step S402), the input and the output unit 101 outputs the multiple signature set σ_{L} without changing it (at step S405).

Through this processing, if a leakage of the secret key of a certain signer occurs, for example, the signer or the administrator of the multiple signature apparatus of the signer can delete the signature that corresponds to the leaked secret key from the multiple signatures using the multiple signature apparatus according to the first embodiment.

As explained above, the multiple signature apparatus according to the first embodiment can delete the signature corresponding to the key that has become unnecessary from the multiple signatures. Therefore, the size of the storage region for storing additional information of the unnecessary key and the unnecessary signature can be reduced, and the multiple signature verification processing can be performed easily.

A multiple signature apparatus according to a second embodiment will be explained. In the multiple signature apparatus according to the first embodiment, the signature deleting unit 106 calculates the intermediate information H(Mᵢ)^{xi} using the hash H(Mᵢ) of the message data and the secret key xi stored in the storage unit 107. In the multiple signature apparatus according to the second embodiment, by contrast, the intermediate information calculated by the signer during the signature creation processing in the past is stored in the storage unit 107, and the multiple signature set is replaced by another multiple signature set using the intermediate information stored in the storage unit 107 during the signature deletion processing.

A configuration of the multiple signature apparatus according to the second embodiment is equal to that of the multiple signature apparatus according to the first embodiment.

In the second embodiment, during the signature creation processing, the hash H(Mᵢ) of the message data Mᵢ is calculated and the intermediate information expressed by Equation (1) is generated using the hash H(Mᵢ) and the secret key xᵢ, and the generated intermediate information is stored in the storage unit 107. The multiple signature verification processing is performed similarly to the verification processing using the multiple signature apparatus according to the first embodiment.

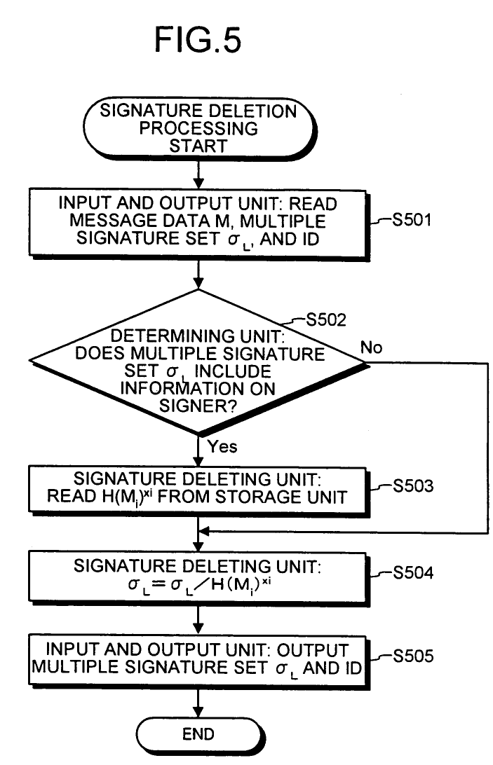

The signature deletion processing using the multiple signature apparatus according to the second embodiment will be explained. FIG. 5 is a flowchart that depicts procedures for the signature deletion processing using the multiple signature apparatus according to the second embodiment.

In the second embodiment, similarly to the first embodiment, the input and output unit 101 reads the message data M=M₁∥ . . . ∥M_{L}, the multiple signature set σ_{L}, and the identifier ID=ID[1]∥ . . . ∥ID[L] (at step S501). The determining unit 104 determines whether signature information of the signer the signature of whom is to be deleted is included in the input multiple signature set σ_{L} (at step S502).

If the determining unit 104 determines that the signature information of the signer is included as i^{th} signature information in the multiple signature set σ_{L}, (“Yes” at step S502), the signature deleting unit 106 reads the intermediate information H(Mᵢ)^{xi} stored in the storage unit 107 (at step S503), and replaces the signature set σ_{L} by the multiple signature set expressed by Equation (5) (at step S504).

As explained above, the multiple signature apparatus according to the second embodiment uses the intermediate information generated and stored in the past during the processing for deleting the signature from the multiple signatures using the intermediate information. Therefore, the operation processing during the signature deletion processing is reduced, thereby making it possible to increase a signature deletion processing rate.

A multiple signature apparatus according to a third embodiment will be explained. In the multiple signature apparatus according to each of the first and the second embodiment, if the information of the specific signer is included in the multiple signatures, the signature of the specific signer is always deleted. The multiple signature apparatus according to the third embodiment, by contrast, selectively deletes a signature in response to a user's indication even if information of specific signer is included in the multiple signatures.

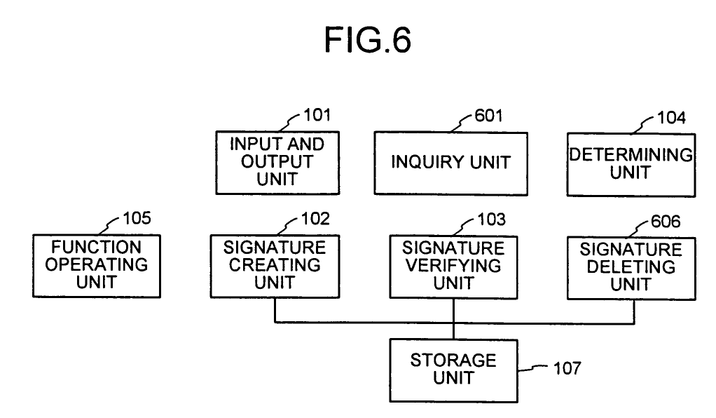

FIG. 6 is a block diagram that depicts a functional configuration of the multiple signature apparatus according to the third embodiment. As shown in FIG. 6, the multiple signature apparatus according to the third embodiment mainly includes the input and output unit 101, the signature creating unit 102, the signature verifying unit 103, the determining unit 104, the function operating unit 105, a signature deleting unit 606, an inquiry unit 601, and the storage unit 107. The input and output unit 101, the signature creating unit 102, the signature verifying unit 103, the determining unit 104, the function operating unit 105, and the storage unit 107 are equal in function to those in the multiple signature apparatus according to the first embodiment, respectively.

If the determining unit 104 determines that the signature information of the specific signer the signature of whom is to be deleted is included in the multiple signature set σ_{L}, then the inquiry unit 601 displays a message or the like on a display device (not shown) to inquire the user (the signer or the administrator) whether the signature is to be deleted, and receives an indication of deletion or non-deletion of the signature.

The signature deleting unit 606 deletes the signature of the specific signer to be deleted among the signers involved in the multiple signatures for the received message data if the inquiry unit 601 receives the user's indication of deletion of the signature.

The signature deletion processing performed by the multiple signature apparatus according to the third embodiment will be explained. It is noted that the signature creation processing and the verification processing are similar to those performed by the multiple signature apparatus according to the first embodiment

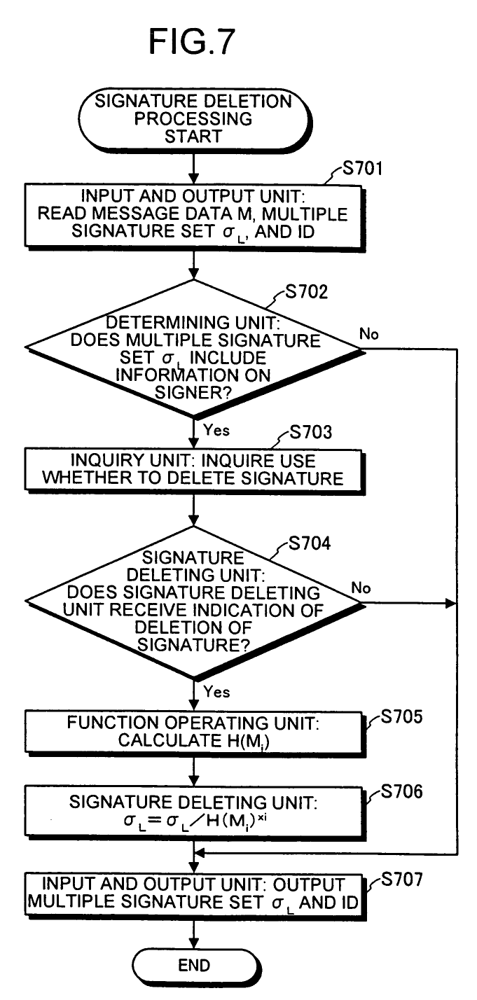

FIG. 7 is a flowchart that depicts procedures for the signature deletion processing using the multiple signature apparatus according to the third embodiment.

In the third embodiment, similarly to the first embodiment, the input and output unit 101 reads the message data M=M₁∥ . . . ∥M_{L}, the multiple signature set σ_{L}, and the identifier ID=ID[1]∥ . . . ∥ID[L] (at step S701). The determining unit 104 determines whether signature information of the signer the signature of whom is to be deleted is included in the input multiple signature set σ_{L} (at step S702).

If the determining unit 104 determines that the signature information of the signer is included as i^{th} signature information in the multiple signature set σ_{L} (“Yes” at step S702), the inquiry unit 601 inquires the user (the signer or the administrator) whether the signature is to be deleted and waits to input an indication as to whether the signature is to be deleted (at step S703).

The signature deleting unit 606 determines whether the inquiry unit 601 receives the indication of deletion of the signature (at step S704). If the inquiry unit 601 receives the indication of non-deletion of the signature (“No” at step S704), the input and output unit 101 outputs the multiple signature set σ_{L} without changing it (at step S707).

If the inquiry unit 601 receives the indication of deletion of the signature (“Yes” at step S704), the function operating unit 105 calculates the hash H(Mᵢ) for the message data Mᵢ changed by the apparatus itself (at step S705). The signature deleting unit 106 generates the intermediate information H(Mᵢ)^{xi} using the hash H(Mᵢ) and the secret key xᵢ of the signer stored in the storage unit 107, and replaces the multiple signature set σ_{L} by the multiple signature set expressed by Equation (5) (at step S706). The input and output unit 101 outputs the changed message data and the identifier together with the replacement multiple signature set (at step S707).

As can be seen, the multiple signature apparatus according to the third embodiment selectively deletes the signature in response to the user's indication even if the information of the specific signer is included in the multiple signatures. Therefore, the signature can be deleted so as to reflect a user's intention.

A multiple signature apparatus according to a fourth embodiment will be explained. The multiple signature apparatus according to the third embodiment selectively deletes the signature in response to the user's indication even if the information of the specific signer is included in the multiple signatures. The multiple signature apparatus according to the fourth embodiment, by contrast, deletes the signature if a certain period passes since creation of the signature.

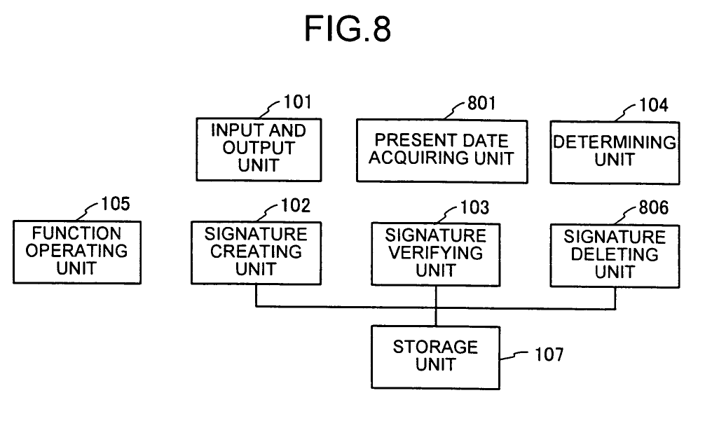

FIG. 8 is a block diagram that depicts a functional configuration of the multiple signature apparatus according to the fourth embodiment. As shown in FIG. 8, the multiple signature apparatus according to the fourth embodiment mainly includes the input and output unit 101, the signature creating unit 102, the signature verifying unit 103, the determining unit 104, the function operating unit 105, a signature deleting unit 806, a present date acquiring unit 801, and the storage unit 107. The input and output unit 101, the signature creating unit 102, the signature verifying unit 103, the determining unit 104, the function operating unit 105, and the storage unit 107 are equal in function to those in the multiple signature apparatus according to the first embodiment.

The present date acquiring unit 801 acquires a present date if the determining unit 104 determines that the signature information of the specific signer the signature of whom is to be deleted is included in the multiple signature set σ_{L}.

The signature deleting unit 806 deletes the signature of the specific signer among the signers involved in the multiple signatures for the message data input if the present date acquired by the present date acquiring unit 801 indicates that a certain period passes since the signature of the specific signer included in the multiple signatures is generated.

It is assumed that the multiple signature apparatus according to the fourth embodiment transmits, as additional information, the signature creation date together with the message data and the multiple signature set to the other multiple signature apparatus during the signature creation processing.

The signature deletion processing performed by the multiple signature apparatus according to the fourth embodiment will be explained. It is noted that the verification processing are similar to those performed by the multiple signature apparatus according to the first embodiment.

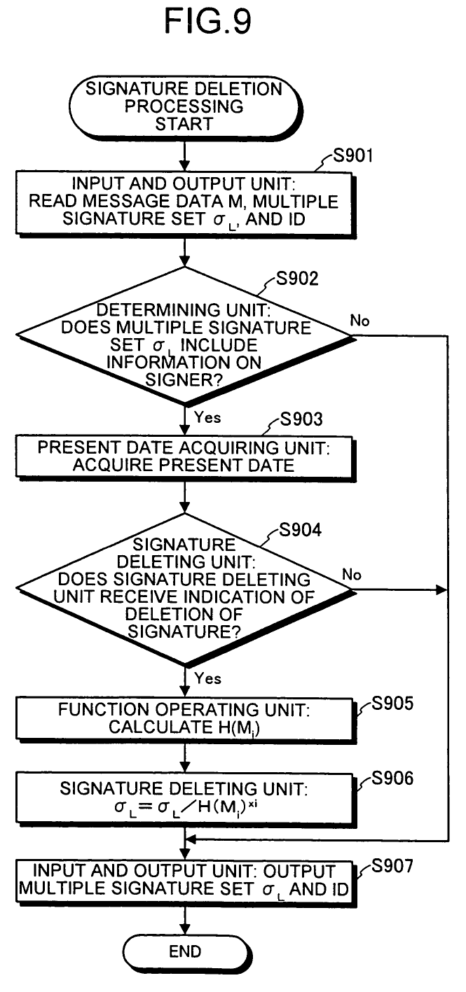

FIG. 9 is a flowchart that depicts the signature deletion processing performed by the multiple signature apparatus according to the fourth embodiment.

In the fourth embodiment, similarly to the first embodiment, the input and output unit 101 reads the message data M=M₁∥ . . . ∥M_{L}, the multiple signature set σ_{L}, and the identifier ID=ID[1]∥ . . . ∥ID[L] (at step S901). The determining unit 104 determines whether signature information of the signer the signature of whom is to be deleted is included in the input multiple signature set σ_{L} (at step S902).

If the determining unit 104 determines that the signature information of the signer is includes as it signature information in the multiple signature set σ_{L} (“Yes” at step S902), the present date acquiring unit 801 acquires a present date (at step S903). The signature deleting unit 606 determines whether a certain period passes since signature creation date that is set as the additional information until the acquired present date (at step S904). The certain period can be arbitrarily set, for example, set at one month, half a month, or one year.

If the signature deleting unit 806 determines that the certain period do not passes since the signature creation date until the acquired present date (“Yes” at step S904), the input and the output unit 101 outputs the multiple signature set σ_{L} without changing it (at step S907).

On the other hand, in step S904, If the signature deleting unit 806 determines that the certain period passes since the signature creation date until the acquired present date, the function operating unit 105 calculates the hash H(Mᵢ) for the message Mᵢ changed by the apparatus itself (at step S905). The signature deleting unit 106 generates the intermediate information H(Mᵢ)^{xi} using the hash H(Mᵢ) and the secret key xᵢ of the signer stored in the storage unit 107, and replaces the multiple signature set σ_{L} by the multiple signature set expressed by the Equation (5) (at step S906). The input and output unit 101 outputs the changed message data and the identifier together with the replacement multiple signature set (at step S907).

As can be seen, if the information of the specific signer is included in the multiple signatures, the multiple signature apparatus according to the fourth embodiment deletes the signature when the certain period passes since the creation date of the signature. Therefore, the signature that becomes unnecessary and for which a substantial period passes since the signature creation date can be automatically deleted.

In the third and the fourth embodiment, the instance of selectively deleting the signature from the multiple signatures by determining the time that passes since the user's indication or the signature date has been explained. Alternatively, the multiple signature apparatus may be constituted to selectively delete the signature under the other conditions.

A multiple signature apparatus according to a fifth embodiment will be explained. The multiple signature apparatus according to each of the first to the fourth embodiments deletes the signature of the specific signer from the multiple signatures. The multiple signature apparatus according to the fifth embodiment can further update the signature of the specific signer to a new signature.

The multiple signature apparatus according to the fifth embodiment creates or updates a signature for the message data, transmits the created or updated signature to the other multiple signature apparatus, verifies the multiple signatures for the message data, manages the multiple signatures, and deletes the signature of the specific signer.

Further, according to the fifth embodiment, a plurality of multiple signature apparatuses are connected to the network such as the Internet. Each signer creates an electronic signature for message data, and transmits the electronic signature to the other multiple signature apparatus on the network using one of the multiple signature apparatuses. When receiving the message data and the multiple signatures, the multiple signature apparatus performs the verification processing on the multiple signatures for the received message data, creates an electronic signature, and transmits the message data and the created electronic signature to the other multiple signature apparatus on the network.

If the signature of the specific signer needs to be updated, the signer or the system administrator of the multiple signature apparatus of the signer can update the signer's signature in the multiple signatures using the multiple signature apparatus used by the signer or the administrator.

The signature creation and update processing, the multiple signature verification processing, and the signature management processing may be executed by different multiple signature apparatuses, respectively.

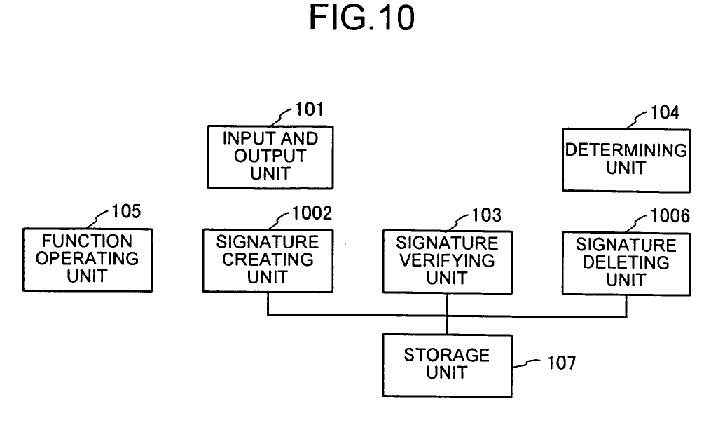

FIG. 10 is a block diagram that depicts a functional configuration of the multiple signature apparatus according to the fifth embodiment As shown in FIG. 10, the multiple signature apparatus according to the fifth embodiment mainly includes the input and output unit 101, a signature creating unit 1002, the signature verifying unit 103, the determining unit 104, the function operating unit 105, a signature deleting unit 1006, and the storage unit 107. The input and output unit 101, the signature verifying unit 103, the function operating unit 105, and the storage unit 107 are equal in function to those in the multiple signature apparatus according to the first embodiment.

The determining unit 104 determines whether the signature of the specific signer to be updated is included in the multiple signature set input by the input and output unit 101.

The signature deleting unit 1006 creates intermediate multiple signature information obtained by deleting the signature of the specific signer from the multiple signatures for the input message data.

The signature creating unit 1002 creates a signature for the message data. The signature creating unit 1002 also updates the signature of the specific signer among those involved in the multiple signatures for the input message data, and creates a new signature. Specifically, the signature creating unit 1002 creates the new signature from the intermediate multiple signature information created by the signature deleting unit 1006.

A signature update processing performed by the multiple signature apparatus according to the fifth embodiment will be explained. It is noted that the signature creation processing and the verification processing are similar to those performed by the multiple signature apparatus according to the first embodiment.

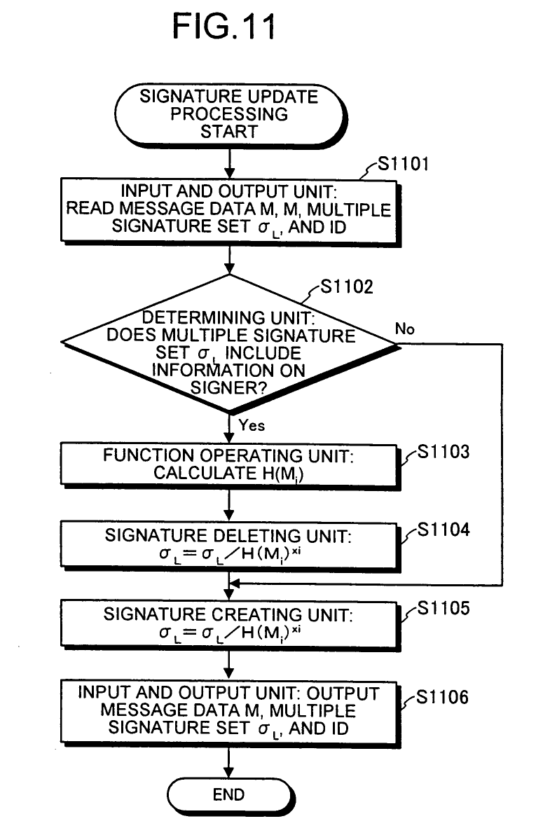

FIG. 11 is a flowchart that depicts procedures for the signature update processing performed by the multiple signature apparatus according to the fifth embodiment.

The input and output unit 101 reads the message data M=M₁∥ . . . ∥M_{L}, the multiple signature set σ_{L}, and the identifier ID=ID[1]∥ . . . ∥ID[L] (at step S1101). The determining unit 104 determines whether signature information of the signer the signature of whom is to be deleted is included in the input multiple signature set σ_{L} (at step S1102).

If the determining unit 104 determines that the signature information of the signer is included as i^{th} signature information in the multiple signature set σ_{L} (“Yes” at step S1102), the function operating unit 105 calculates the hash H(Mᵢ) for the message Mᵢ changed by the apparatus itself (at step S1103). The signature deleting unit 106 generates intermediate information H(Mᵢ)^{xi} using the hash H(Mᵢ) and the secret key xᵢ of the signer stored in the storage unit 107, and replaces the multiple signature set σ_{L} by the multiple signature set expressed by Equation (5) (at step S1104). The replacement multiple signature set σ_{L} is set as the intermediate multiple signature information. This intermediate multiple signature information serves as multiple signatures from which the signature of the specific signer is deleted. At this time, the message Mᵢ in the message data and the identifier ID[i] of the signer in the identification information are deleted, thereby replacing the message data and the identifier ID by M=M₁∥ . . . Mᵢ₋₁∥Mᵢ₊₁∥ . . . ∥M_{L} and ID=ID[1]∥ . . . ∥ID[i−1]∥ID[i+1]∥ . . . ∥ID[L], respectively.

If it is determined at step S1102 that the signature information of the signature is not included in the multiple signature set σ_{L} (“No” at step S1102), the input and the output unit 101 outputs the multiple signature set σ_{L} without changing it (at step S1105).

The signature creating unit 1002 calculates a new multiple signature set σ_{L} as expressed by the following Equation (6) using the hash H(Mᵢ) calculated by the function operating unit 105, the intermediate multiple signature information σ_{L}, and the secret key xᵢ stored in the storage unit 107 (at step S1105).
σ_{L}′=σ_{L}H(Mᵢ′)xᵢ (6)

The input and output unit 101 outputs the message data M=M₁∥ . . . Mᵢ₋₁∥Mᵢ₊₁∥ . . . ∥M_{L′}∥M_{i′}, the new multiple signature set σ_{L′}, and the identifier ID=ID[1]∥ . . . ∥ID[i−1]∥ID[i+1]∥ . . . ∥ID[L]∥ID[i] (at step S1106).

Through this processing, the signature of the specific signer among the multiple signatures is updated.

As explained above, the multiple signature apparatus according to the fifth embodiment can create the signature for new message data including the past message data after deleting the signature information created in the past from the multiple signatures if it is necessary to do so. Therefore, even if the signature to be updated is present in the multiple signatures, the storage region necessary for the electronic signature creation and verification processings such as the region for storing the additional information generated by the signer a plurality of times can be reduced. In addition, the multiple signature verification processing can be performed easily.

The instance of medical institutions will be explained, for example. When the patient takes medical advice in the medical institution A the second time, the multiple signature apparatus used by the medical institution A determines whether the signature created by the apparatus of the institution A is included in the multiple signatures, deletes the signature created for a first visit, and newly creates a signature for a second visit. According to the multiple signature scheme that includes the message flexibility, when the new signature is created, the message including date information corresponding to the signature created in the past, a date when the patient takes medical advice in the medical institution A the second time, and a result of the medical advice are regarded as a new message, and multiple signatures are created. It is thereby possible to reduce additional information and verification cost without losing security of the past message.

A multiple signature apparatus according to a sixth embodiment will be explained. The multiple signature apparatus according to the fifth embodiment always updates the signature of the specific signer during the signature update processing if the information of the specific signer is included in the multiple signatures. The multiple signature apparatus according to the sixth embodiment, by contrast, selectively performs a processing for simply deleting the signature and the signature update processing if the information of the specific signer is included in the multiple signatures.

The multiple signature apparatus according to the sixth embodiment is equal in configuration to the multiple signature apparatus according to the fifth embodiment.

The multiple signature apparatus according to the sixth embodiment inputs a signature creation bit that indicates whether to update the signature and create a new signature together with the message data and the multiple signature set. If this signature creation bit is “0”, this means that a signature is not created for the new message. If the signature creation bit is “1”, this means that the signature is created for the new message. In this specification, the signature creation bit is also used as signature creation information.

The signature update processing performed by the multiple signature apparatus according to the sixth embodiment will be explained. It is noted that the signature creation processing and the verification processing are similar to those performed by the multiple signature apparatus according to the first embodiment.

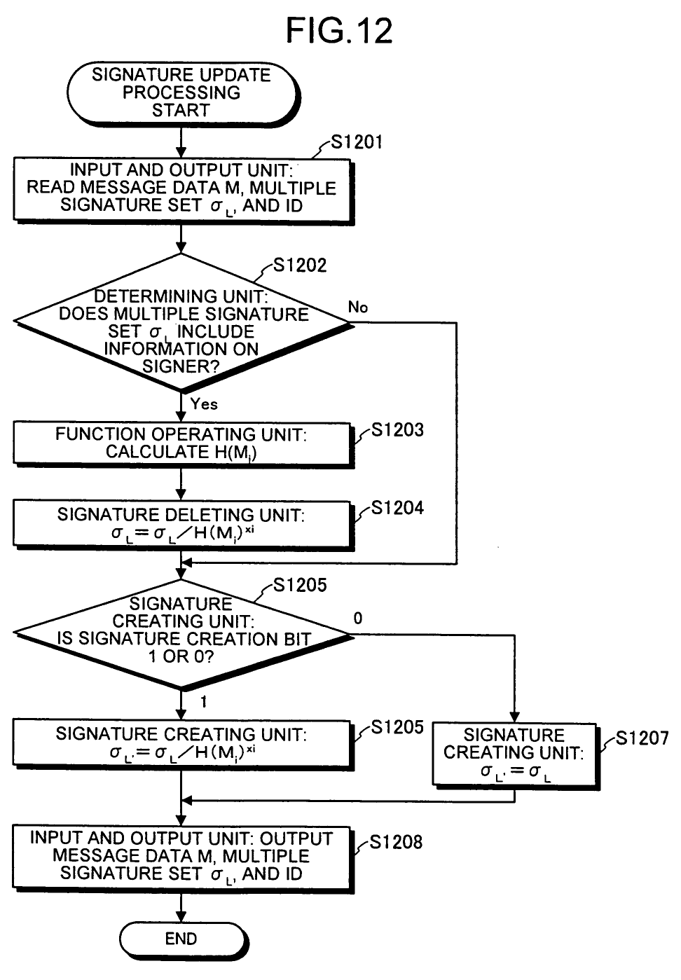

FIG. 12 is a flowchart that depicts procedures for the signature update processing performed by the multiple signature apparatus according to the sixth embodiment.

In the sixth embodiment, similarly to the fifth embodiment the processing since the input and output unit 101 reads the message data M=M₁∥ . . . ∥M_{L}, message data Mᵢ′, the multiple signature set σ_{L}, and the identifier ID=ID[1]∥ . . . ∥ID[L] until the intermediate multiple signature information σ_{L} is created (at steps S1201 to S1204) is performed similarly to the signature update processing (at steps S1101 to S1104) according to the fifth embodiment

When the intermediate multiple signature information σ_{L} is created, the signature creation bit is checked (at step S1205). If the signature creation bit is “1”, the signature creating unit 1002 performs an operation expressed by Equation (6) using the hash H(Mᵢ′) calculated by the function operating unit 105, the intermediate multiple signature information σ_{L}, and the secret key xᵢ stored in the storage unit 107, thereby calculating the new multiple signature set σ_{L}′ (at step S1206). The input and output unit 101 outputs the message data M=M₁∥ . . . Mᵢ₋₁∥Mᵢ₊₁∥ . . . ∥M_{L}∥Mᵢ′, the new multiple signature set σ_{L}′, and the identifier ID=ID[1]∥ . . . ∥ID[i−1]∥ID[i+1]∥ . . . ∥ID[L]∥ID[i] (at step S1207).

If it is checked that the signature creation bit is “0” at step S1205, the intermediate multiple signature information that serves as the multiple signatures from which the signature of the specific signer is deleted is set as the multiple signature set σ_{L}′ (at step S1207) and this multiple signature set σ_{L}′ is output (at step S1208). Therefore, if the signature creation bit is “0”, only the signature of the specific signature is deleted from the multiple signatures without updating the signature of the specific signer.

As can be seen, the multiple signature apparatus according to the sixth embodiment determines whether to update a signature in the multiple signatures based on the signature creation bit. Therefore, it is possible to selectively update the signature.

A multiple signature apparatus according to a seventh embodiment will be explained. The multiple signature apparatus according to the sixth embodiment determines whether to update a signature in the multiple signatures or only delete the signature based on the signature creation bit and selectively updates the signature. The multiple signature apparatus according to the seventh embodiment, by contrast, selectively updates or deletes a signature in response to a user's indication.

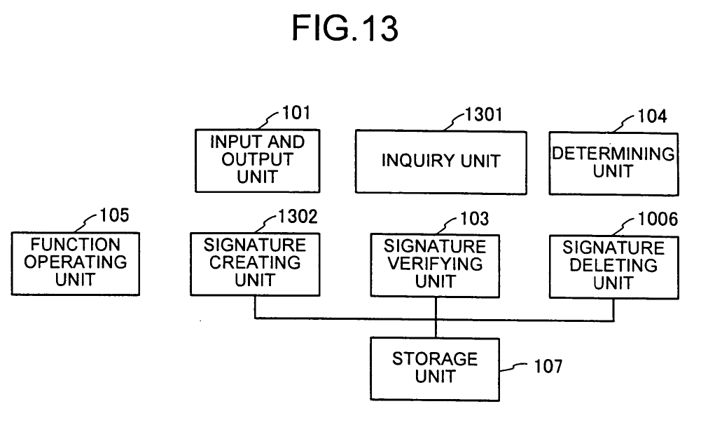

FIG. 13 is a block diagram that depicts a functional configuration of the multiple signature apparatus according to the seventh embodiment. As shown in FIG. 13, the multiple signature apparatus according to the seventh embodiment includes the input and output unit 101, a signature creating unit 1302, the signature verifying unit 103, the determining unit 104, the function operating unit 105, the signature deleting unit 1006, an inquiry unit 1301, and the storage unit 107. The input and output unit 101, the signature verifying unit 103, the signature deleting unit 1006, the determining unit 104, the function operating unit 105, and the storage unit 107 are equal in function to those in the multiple signature apparatus according to the fifth embodiment.

The inquiry unit 1301 displays a message or the like on the display device (not shown) to inquire the user (the signer or the administrator) whether to update a signature, that is, whether to create a new multiple signature set, and receives an indication of creation of the new multiple signature set or non-creation of the new multiple signature set as signature creation information.

The signature creating unit 1302 creates the new multiple signature set from the intermediate multiple signature information created by the signature deleting unit 1006 if the user's indication of creation of the new multiple signature set is input to the inquiry unit 1301 as the signature creation information. The signature creating unit 1302 performs a processing for leaving the intermediate multiple signature information as the multiple signature set to be output if the user's indication of non-creation of the new multiple signature set is input to the inquiry unit 1301.

The signature update processing performed by the multiple signature apparatus according to the seventh embodiment will be explained. It is noted that the signature creation processing and the verification processing are similar to those performed by the multiple signature apparatus according to the first embodiment.

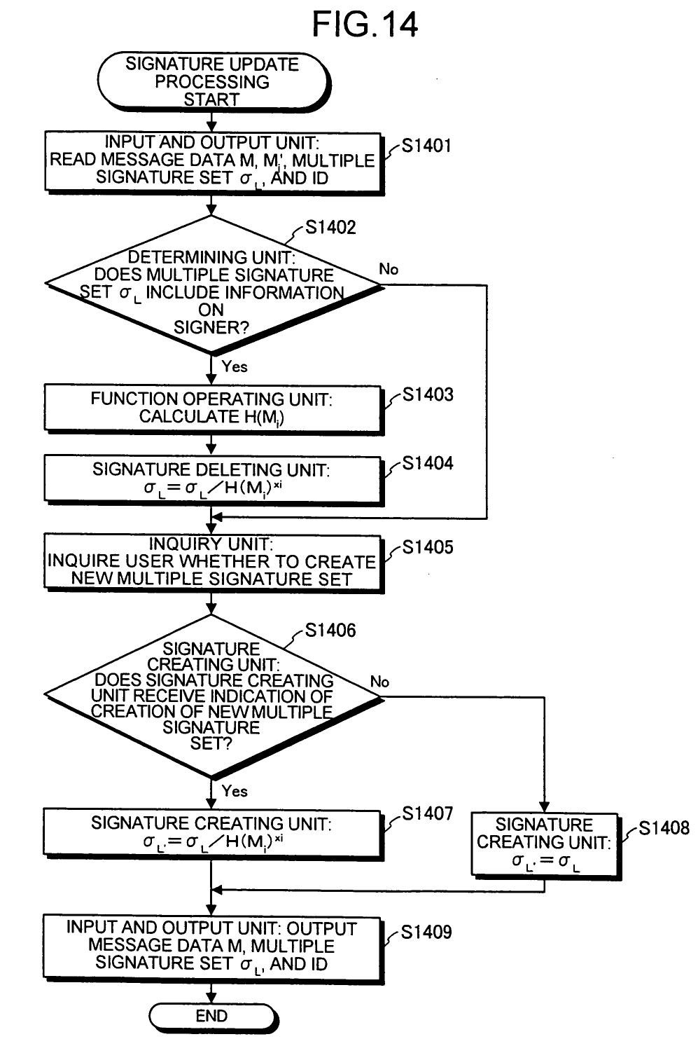

FIG. 14 is a flowchart that depicts procedures for the signature update processing performed by the multiple signature apparatus according to the seventh embodiment.

In the seventh embodiment, similarly to the fifth embodiment, the processing since the input and output unit 101 reads the message data M=M₁∥ . . . ∥M_{L}, message data Mᵢ′, the multiple signature set σ_{L}, and the identifier ID=ID[1)]∥ . . . ∥ID[L] until the intermediate multiple signature information σ_{L} is created (at steps S1401 to S1404) is performed similarly to the signature update processing (at steps S1101 to S1104) according to the fifth embodiment.

When the intermediate multiple signature information σ_{L} is created, the inquiry unit 1301 inquires the user (the signer or the administrator) whether to create a new multiple signature set and waits to input signature creation information that indicates whether to create the new multiple signature set (at step S1405).

The signature creating unit 1302 determines whether the signature creation information that indicates that the new multiple signature set is created is input from the inquiry unit 1301 (at step S1406). If determining that the signature creation information that indicates that the new multiple signature set is created is input from the inquiry unit 1301 (“Yes” at step S1406), the signature creating unit 1302 performs an operation expressed by Equation (6) using the hash H(Mᵢ′) calculated by the function operating unit 105, the intermediate multiple signature information σ_{L}, and the secret key xᵢ stored in the storage unit 107, thereby calculating the new multiple signature set σ_{L}′ (at step S1407). The input and output unit 101 outputs the message data M=M₁∥ . . . Mᵢ₋₁∥Mᵢ₊₁∥ . . . ∥M_{L}∥Mᵢ′, the new multiple signature set σ_{L}′, and the identifier ID=ID[1]∥ . . . ∥ID[i−1]∥ID[i+1]∥ . . . ∥ID[L]∥ID[i] (at step S1409).

If the signature creating unit 1302 determines that the signature creation information that indicates that the new multiple signature set is not created is input from the inquiry unit 1301 (“No” at step S1406), the intermediate multiple signature information that serves as the multiple signatures from which the signature of the specific signer is deleted is set as the multiple signature set σ_{L}′ (at step S1408) and this multiple signature set σ_{L}′ is output together with the message data M=M₁∥ . . . Mᵢ₋₁∥Mᵢ₊₁∥ . . . ∥M_{L}∥Mᵢ′ and the identifier ID=ID[1]∥ . . . ∥ID[i−1]∥ID[i+1]∥ . . . ∥ID[L]∥ID[i] (at step S1409). Therefore, if the signature creation bit is “0”, only the signature of the specific signature is deleted from the multiple signatures without updating the signature of the specific signer.

As can be seen, the multiple signature apparatus according to the seventh embodiment determines whether to update the signature in the multiple signatures based on the user's indication. Therefore, it is possible to selectively update the signature so as to reflect the user's intention.

A multiple signature apparatus according to an eighth embodiment will be explained. The multiple signature apparatus according to the seventh embodiment selectively updates the signature in response to the user's indication. The multiple signature apparatus according to the eighth embodiment, by contrast, updates a signature if a certain period passes since creation of the signature.

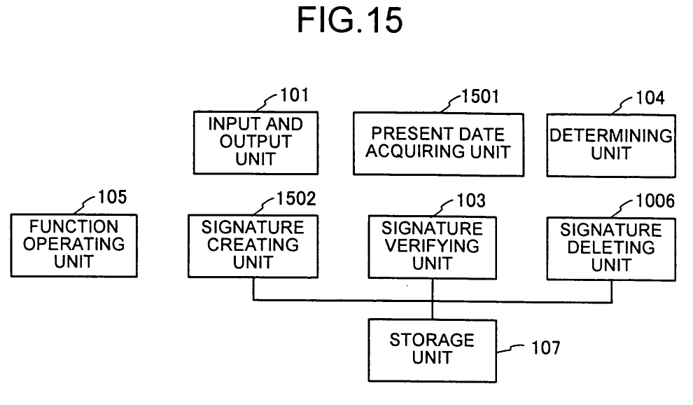

FIG. 15 is a block diagram that depicts a functional configuration of the multiple signature apparatus according to the seventh embodiment. As shown in FIG. 15, the multiple signature apparatus according to the eighth embodiment includes the input and output unit 101, a signature creating unit 1502, the signature verifying unit 103, the determining unit 104, the function operating unit 105, the signature deleting unit 1006, a present date acquiring unit 1501, and the storage unit 107. The input and output unit 101, the signature verifying unit 103, the signature deleting unit 1006, the determining unit 104, the function operating unit 105, and the storage unit 107 are equal to those in the multiple signature apparatus according to the fifth embodiment.

The present date acquiring unit 1501 acquires a present date if the determining unit 104 determines that the signature information of the specific signer the signature of whom is to be deleted is included in the multiple signature set σ_{L}.

The signature creating unit 1502 creates a new multiple signature set from the intermediate multiple signature information created by the signature deleting unit 1006 if the present date acquired by the present date acquiring unit 801 indicates that a certain period passes since the creation date of the signature of the specific signer included in the multiple signatures. The signature creating unit 1502 performs a processing for leaving the intermediate multiple signature information as the multiple signature set to be output if the certain period does not pass.

It is assumed that the multiple signature apparatus according to the eighth embodiment transmits, as additional information, the signature creation date together with the message data and the multiple signature set to the other multiple signature apparatus during the signature creation processing.

The signature update processing performed by the multiple signature apparatus according to the eighth embodiment will be explained. It is noted that the signature creation processing and the verification processing are similar to those performed by the multiple signature apparatus according to the first embodiment.

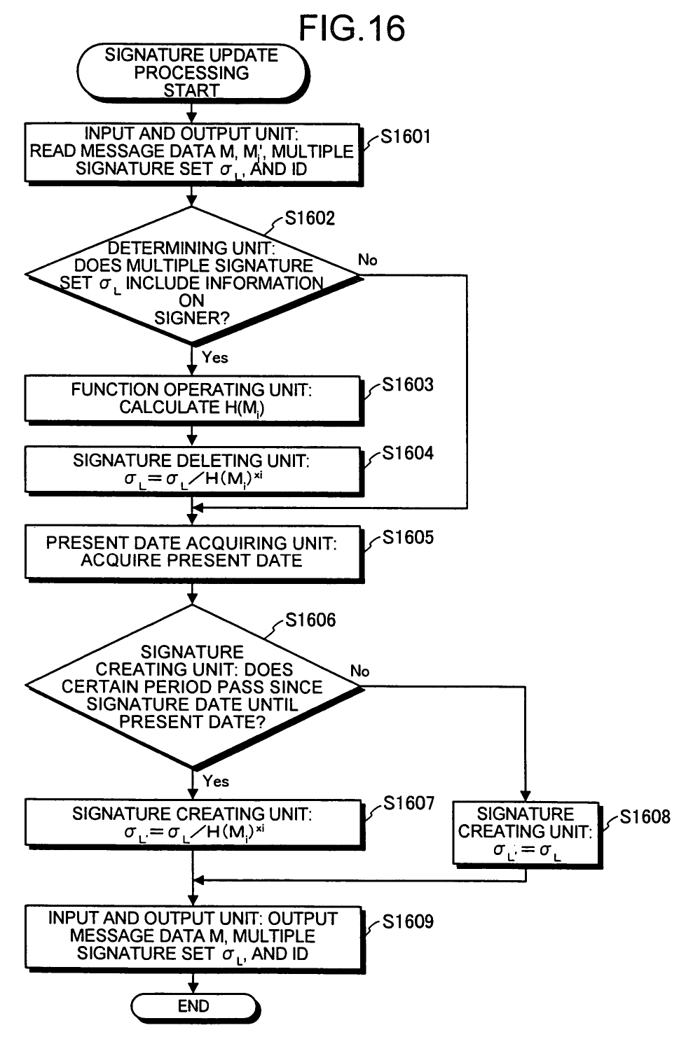

FIG. 16 is a flowchart that depicts the signature update processing performed by the multiple signature apparatus according to the eighth embodiment.

In the eighth embodiment, similarly to the fifth embodiment, the processing since the input and output unit 101 reads the message data M=M₁∥. . . ∥M_{L}, message data Mᵢ′, the multiple signature set σ_{L}, and the identifier ID=ID[1]∥ . . . ∥ID[L] until the intermediate multiple signature information σ_{L} is created (at steps S1601 to S1604) is performed similarly to the signature update processing (at steps S1101 to S1104) according to the fifth embodiment.

When the intermediate multiple signature information σ_{L} is created, the present date acquiring unit 1501 acquires the present date (at step S1605).

The signature creating unit 1502 determines whether the certain period passes since the signature creation date that is set as the additional information until the acquired present date (at step S1606). The certain period can be arbitrarily set, for example, set at one month, half a month, or one year.

If the signature creating unit 1502 determines that the certain period passes since the signature creation date until the acquired present date (“Yes” at step S1606), the signature creating unit 1502 performs an operation expressed by Equation (6) using the hash H(Mᵢ′) calculated by the function operating unit 105, the intermediate multiple signature information σ_{L}, and the secret key xᵢ stored in the storage unit 107, thereby calculating the new multiple signature set σ_{L}′ (at step S1607). The input and output unit 101 outputs the message data M=M₁∥ . . . M₁₋₁∥Mᵢ₊₁∥ . . . ∥M_{L}∥Mᵢ′, the new multiple signature set σ_{L}′, and the identifier ID=ID[1]∥ . . . ∥ID[i−1]∥ID[i+1]∥ . . . ∥ID[L]∥ID[i] (at step S1609).

If the signature creating unit 1502 determines that the present date does not indicate that the certain period passes since the signature creation date (“No” at step S1606), the intermediate multiple signature information that serves as the multiple signatures from which the signature of the specific signer is deleted is set as the multiple signature set σ_{L}′ (at step S1608) and this multiple signature set σ_{L}′ is output together with the message data M=M₁∥ . . . Mᵢ₋₁∥Mᵢ₊₁∥ . . . ∥M_{L}∥Mᵢ′ and the identifier ID=ID[1]∥ . . . ∥ID[i−1]∥ID[i+1]∥ . . . ∥ID[L]∥ID[i] (at step S1609). Therefore, if the present date does not indicate that the certain time passes since the signature creation date, only the signature of the specific signature is deleted from the multiple signatures without updating the signature of the specific signer.

As can be seen, the multiple signature apparatus according to the eighth embodiment updates the signature when the certain time passes since the signature creation date. Therefore, the signature that becomes unnecessary and for which a substantial period passes since the signature creation date can be automatically updated.

In the sixth to the eighth embodiments, the instance of selectively updating the signature in the multiple signatures based on the signature creation bit, the user's indication, or determination of the passage of time since the signature creation date has been described. Alternatively, the signature can be selectively updated based on the other conditions.

Further, in the first to the eighth embodiments, the function operating unit 105 operates the hash of the input message data so as to use this hash for deletion or update of the signature. However, the present invention is not limited to the instance. For example, the multiple signature apparatus can be constituted to encrypt the message data input by the function operating unit 105 using a predetermined key, and to use the encrypted message data for deletion or update of the signature.

Each of the multiple signature apparatuses according to the first to the eighth embodiments explained so far includes a control device such as a CPU, a storage device such as a read only memory (ROM) or random access memory (RAM), an external storage device such as a HDD or a CD drive, the display device such as a display unit, and an input device such as a keyboard and a mouse. The multiple signature apparatus has a hardware configuration using an ordinary computer.

A computer program that allows each of the multiple signature apparatuses according to the first to the eighth embodiments to execute the multiple signature processing is provided by being recorded in a computer readable recording medium such as a CD-ROM, a flexible disk (FD), a CD-R, or a digital versatile disk (DVD) as a file in an installable form or executable form.

Alternatively, such a computer program may be provided by being stored in a computer connected to the network such as the Internet and being downloaded through the network. The computer program may be provided or distributed through the network such as the Internet, or provided while being incorporated in a ROM or the like in advance.

Such a computer program may be constituted by modules that functionally include the respective units (the input and output unit, the signature creating unit, the signature verifying unit, the determining unit, the function operating unit, the signature deleting unit, the inquiry unit, the present date acquiring unit). In an actual hardware configuration, a CPU (processor) may read the computer program from the storage medium and executes the computer program. By doing so, the respective units may be loaded on a main storage device, and the input and output unit, the signature creating unit, the signature verifying unit, the determining unit, the function operating unit, the signature deleting unit, the inquiry unit, the present date acquiring unit may be generated on the main storage device.

In the first to the eighth embodiments, the instance of applying the signature deletion processing and the signature update processing to the multiple signature scheme proposed in the Boneh et al. has been explained for brevity of explanation. However, the signature deletion processing and the signature update processing performed by the multiple signature apparatus according to the present invention can be also applied to the aggregate signature created after performing the processing based on the conventional aggregate signature scheme proposed in the Boneh et al.

Further advantages and modifications can be readily deduced by one skilled in the art. Although the invention has been described with respect to specific embodiments for a complete and clear disclosure, the appended claims are not to be thus limited but are to be construed as embodying all modifications and alternative constructions that may occur to one skilled in the art which fairly fall within the basic teaching herein set forth.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A multiple signature apparatus comprising:
a determining unit that determines whether signature information of a specific signer is included in multiple signatures created by a plurality of signers for message data; and
a signature deleting unit that deletes the signature information of the specific signer from the multiple signatures based on intermediate information created from the message data during creation of a signature by the specific signer if the determining unit determines that the signature information of the specific signer is included in the multiple signatures.

2. The multiple signature apparatus according to claim 1, further comprising an intermediate information storage unit that stores the intermediate information, wherein
the signature deleting unit deletes the signature information of the specific signer from the multiple signatures based on the intermediate information stored in the intermediate information storage unit if the determining unit determines that the signature information of the specific signer is included in the multiple signatures.

3. The multiple signature apparatus according to claim 1, further comprising an inquiry unit that inquires a user whether to delete the signature information of the specific signer, wherein
the signature deleting unit deletes the signature information of the specific signer from the multiple signatures based on the intermediate information if the determining unit determines that the signature information of the specific signer is included in the multiple signatures and if the inquiry unit transmits an indication of deletion of the signature information of the specific signer to the signature deleting unit.

4. The multiple signature apparatus according to claim 1, further comprising a present date acquiring unit that acquires a present date, wherein
the signature deleting unit deletes the signature information of the specific signer from the multiple signatures based on the intermediate information if the determining unit determines that the signature information of the specific signer is included in the multiple signatures and if a preset period passes since a date when the specific signer creates the signature information until the present date acquired by the present date acquiring unit.

5. The multiple signature apparatus according to claim 1, further comprising an operating unit that performs an encryption processing on the message data, and that creates encrypted message information, wherein
the signature deleting unit deletes the signature information of the specific signer from the multiple signatures based on the encrypted message information created by the operating unit and the intermediate information if the determining unit determines that the signature information of the specific signer is included in the multiple signatures that includes the encrypted message information.

6. The multiple signature apparatus according to claim 5, further comprising a key storage unit that stores key information of the signers, wherein
the operating unit performs a unidirectional function on the message data using the key information stored in the key storage unit, and creates authentication code information as the encrypted message information, and
the signature deleting unit deletes the signature information of the specific signer from the multiple signatures based on intermediate information obtained by decoding the authentication code information using the key information if the determining unit determines that the signature information of the specific signer is included in the multiple signatures that include the authentication code information.

7. A multiple signature apparatus comprising:
a determining unit that determines whether signature information of a specific signer is included in multiple signatures created by a plurality of signers for message data;
a signature deleting unit that creates intermediate multiple signature information obtained by deleting the signature information of the specific signer from the multiple signatures based on intermediate information created from the message data during creation of a signature by the specific signer if the determining unit determines that the signature information of the specific signer is included in the multiple signatures; and
a signature creating unit that creates new multiple signatures based on the intermediate multiple signature information and the message data if the determining unit determines that the signature information of the specific signer is included in the multiple signatures.

8. The multiple signature apparatus according to claim 7, wherein
the signature creating unit crates the new multiple signatures based on the multiple signatures and the message data if the determining unit determines that the signature information of the specific signer is not included in the multiple signatures.

9. The multiple signature apparatus according to claim 7, wherein
the signature creating unit determines whether to create the new multiple signatures based on signature creation information that indicates whether to further create new multiple signatures as the multiple signatures, and
if the determining unit determines that the signature information of the specific signer is included in the multiple signatures and if the signature creation information indicates creation of the new multiple signatures, the signature creating unit creates the new multiple signatures based on the intermediate multiple signature information and the message data.

10. The multiple signature apparatus according to claim 9, wherein
the multiple signatures include the signature creation information, and
the signature creating unit determines whether to create the new multiple signatures based on the signature creation information included in the multiple signatures.

11. The multiple signature apparatus according to claim 9, further comprising an inquiry unit that inquires a user whether to create the new multiple signatures, and that acquires an indication as to whether to create the new multiple signatures as the signature creation information, wherein
if the determining unit determines that the signature information of the specific signer is included in the multiple signatures and if the signature creation information acquired by the inquiry unit is an indication of creation of the new multiple signatures, the signature creating unit creates the new multiple signatures based on the intermediate multiple signature information and the message data.

12. The multiple signature apparatus according to claim 7, further comprising a present date acquiring unit that acquires a present date, wherein
the signature deleting unit creates the new multiple signatures based on the intermediate multiple signature information and the message data if the determining unit determines that the signature information of the specific signer is included in the multiple signatures and a preset period passes since a date when the specific signer creates the signature information until the present date acquired by the present date acquiring unit.

13. The multiple signature apparatus according to claim 7, further comprising an operating unit that performs an encryption processing on the message data, and that generates encrypted message information, wherein
the signature deleting unit deletes the signature information of the specific signer from the multiple signatures and creates the intermediate multiple signature information based on the encrypted message information created by the operating unit and the intermediate information if the determining unit determines that the signature information of the specific signer is included in the multiple signatures that includes the encrypted message information.

14. The multiple signature apparatus according to claim 13, further comprising a key storage unit that stores key information of the signers, wherein
the operating unit performs a unidirectional function on the input message data using the key information stored in the key storage unit, and creates authentication code information as the encrypted message information,
the signature deleting unit deletes the signature information of the specific signer from the multiple signatures and creates the intermediate multiple signature information based on the intermediate information obtained by decoding the authentication code information using the key information if the determining unit determines that the signature information of the specific signer is included in the multiple signatures that include the authentication code information, and
the signature creating unit creates the new multiple signatures based on the intermediate multiple signature information and the authentication code information if the determining unit determines that the signature information of the specific signer is included in the multiple signatures.

15. A multiple signature method comprising:
determining whether signature information of a specific signer is included in multiple signatures created by a plurality of signers for message data; and
deleting the signature information of the specific signer from the multiple signatures based on intermediate information created from the message data during creation of a signature by the specific signer if the determining unit determines that the signature information of the specific signer is included in the multiple signatures.

16. A multiple signature method comprising:
determining whether signature information of a specific signer is included in multiple signatures created by a plurality of signers for message data;
creating intermediate multiple signature information obtained by deleting the signature information of the specific signer from the multiple signatures based on intermediate information created from the message data during creation of a signature by the specific signer if the determining unit determines that the signature information of the specific signer is included in the multiple signatures; and
creating new multiple signatures based on the intermediate multiple signature information and the message data if the determining unit determines that the signature information of the specific signer is included in the multiple signatures.

17. A computer program product having a computer readable medium including programmed instructions, wherein the instructions, when executed by a computer, cause the computer to perform:
determining whether signature information of a specific signer is included in multiple signatures created by a plurality of signers for message data; and
deleting the signature information of the specific signer from the multiple signatures based on intermediate information created from the message data during creation of a signature by the specific signer if the determining unit determines that the signature information of the specific signer is included in the multiple signatures.

18. A computer program product having a computer readable medium including programmed instructions, wherein the instructions, when executed by a computer, cause the computer to perform:
determining whether signature information of a specific signer is included in multiple signatures created by a plurality of signers for message data;
creating intermediate multiple signature information obtained by deleting the signature information of the specific signer from the multiple signatures based on intermediate information created from the message data during creation of a signature by the specific signer if the determining unit determines that the signature information of the specific signer is included in the multiple signatures; and
creating new multiple signatures based on the intermediate multiple signature information and the message data if the determining unit determines that the signature information of the specific signer is included in the multiple signatures.
